(19) United States
(12) Patent Application Publication
(10) Pub. No.: US 2013/0212598 A1
(43) Pub. Date: Aug. 15, 2013

(54) DEPENDENCY INFORMER

(71) Applicant: Edan Doitch, Tel Aviv (IL)

(72) Inventor: Edan Doitch, Tel Aviv (IL)

(73) Assignee: MICROSOFT CORPORATION, Redmond, WA (US)

(21) Appl. No.: 13/372,528

(22) Filed: Feb. 14, 2012

(51) Int. Cl. G06F 9/44

(52) U.S. Cl. 719/318

(57) ABSTRACT

A dependency informer can enable the set of connections between pairs of elements in one or more entities to be defined. The set of definitions can be used by the dependency informer to select custom code to invoke. Custom code can be invoked by firing an event at a first entity. When the dependency informer receives the parameterized event from the first subject, custom code can be invoked for an identified element specified by a parameter. Custom code behavior can be defined for each type of event generated by the first subject. Hence, receiving a single event generated by the first subject can result in multiple different actions or events being fired in the second subject.

### BACKGROUND

The publish-subscribe pattern is a messaging pattern used in software design in which publishers publish messages that are delivered to unknown subscribers. Published messages are characterized into classes. A subscriber can express an interest in (subscribe to) one or more classes of messages without knowing who publishes the message. In response to subscribing to one or more classes of messages, the subscriber will receive only those messages to which the subscriber has subscribed.

The observer pattern (a subset of the publish/subscribe pattern) is a software design pattern in which the subject maintains a list of observers, and automatically notifies them of changes in state. The observer pattern is often used to implement event handling systems. The observer pattern defines a one-to-many dependency between elements so that when one element changes state, all the elements dependent on the changed element are notified and updated automatically.

### SUMMARY

An observer pattern of software design can include a first subject and a second subject. The first subject can be the same entity as the second subject. The second subject can contain or include the first subject. The pattern can also include entities comprising a first observer and a second observer. The same entity can be both the first observer and the second subject.

A dependency informer can enable one or more sets of connections between pairs of elements in one or more entities to be defined. The definition can indicate identifiers (e.g., names, codes, etc.) of both elements. A set of definitions can be used by the dependency informer to select an event to fire in the second subject or a custom delegate to invoke when receiving an event from the first subject. The dependency informer can enable custom program code to be defined. The custom code can be invoked when an event is fired with a particular parameter value. Consequently, instead of registering for a single event fired by the first subject and having a single type of outcome for the event, a single event in the first subject can cause several different outcomes by generating several different types of events to be generated by the second subject. Custom code behavior can be defined for each event generated by the first subject, based on a parameter or parameters associated with the event. Hence, receiving a single event generated by the first subject can result in multiple different events being applied to one or more observers.

An example of an implementation of the described observer pattern in software design is a Model View View-Model (MVVM) architecture. In one implementation, the first subject can be the Model, a first observer and second subject can be a View-Model and a second observer can be a View. A set of definitions can be used by the dependency informer to select the correct event to fire in the view-model when receiving an event from the model. The dependency informer can enable defined custom code to be invoked when an event is fired for a particular element in the model. Consequently, instead of registering for a single event fired by the model and having a single type of outcome for the event, a single event in the model can cause several different outcomes by generating several different types of events to be generated by the view-model. Custom code behavior can be defined for each event generated by the model, based on the parameter or parameters associated with the event. Hence, receiving a single event generated by the model can result in multiple different events being applied to one or more views.

The first subject, second subject, first observer and second observer can be objects. An object (e.g., the dependency informer) can be created to forward events from the first subject (e.g., the model) to the second subject (e.g., the view-model) by defining element pairs. The object can include logic to determine the effects of the forwarding.

A single event in the first subject may include one or more parameters that result in the different events being generated in the second subject. In response to detecting an event fired by the first subject, the event including one or more parameters or delegates, the dependency informer can execute customized code. The parameter or parameters can be used to distinguish between different events. Optionally, the order in which the delegates are invoked can be prioritized. A delegate can be an object that performs a task for another object. A delegate can act as a pointer to a function by specifying a method to call and, optionally, an object on which to call the method. A delegate can encapsulate within it a reference to a method, enabling the delegate object to be passed to code which can call the referenced method, without having to know at compile time which method will be invoked.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings:

FIG. 1a illustrates an example of a system 100 that applies events fired by a first subject (e.g., a model) to a second observer (e.g., a view) by defining dependencies in accordance with aspects of the subject matter disclosed herein;

FIG. 1b illustrates an example 120 of connections between a first subject (e.g., a model), first observer/second subject (e.g., a view-model) and a second observer (e.g. view) in accordance with aspects of the subject matter disclosed herein;

FIG. 1c illustrates an example 170 of a dependency informer and interface in accordance with aspects of the subject matter disclosed herein;

FIG. 2 illustrates an example of a method 200 that receives an event fired by a first subject (e.g., a model) and generates one or more events to be applied to a second observer (e.g., a view) or invokes one of more delegates in accordance with aspects of the subject matter disclosed herein;

FIG. 3 is a block diagram of an example of a computing environment in accordance with aspects of the subject matter disclosed herein; and

FIG. 4 is a block diagram of an example of an integrated development environment in accordance with aspects of the subject matter disclosed herein.

### DETAILED DESCRIPTION

### Overview

When developing interactive applications, design considerations include separating an application's data, presentation, and user input into specialized components. Several different architecture patterns that are implementations of the observer pattern described above have evolved to address these considerations. The Model View Presenter (MVP) pattern is used mostly for building user interfaces (UIs). In the MVP pattern the model is an interface defining the data to be displayed or otherwise acted upon in the user interface, the view is an interface that displays data from the model and routes user commands (events) to the presenter to act upon that data and the presenter acts upon the model and the view. The presenter retrieves data from repositories (the model), and formats it for display in the view. In the Model View View-Model (MVVM) pattern, the model can refer to either an object model that represents the real state content (an object-oriented approach), or the model can refer to a data access layer that represents that content (a data-centric approach). The view typically refers to all elements displayed by the including buttons, windows, graphics, and other controls. The View-Model is a Model of the View meaning it is an abstraction of the View that also serves in data binding between the View and the Model. The View-Model exposes public properties, commands, and abstractions.

Binding in user interfaces of applications is commonly used to synchronize state between the view (which displays the data and with which the user can interact) and the model (which holds the current state of the data). The result of binding typically applies changes made in the view to the model. Changes in the model are not directly assigned to the view. Instead, to apply changes made in the model to the view, the model fires a change event that is caught by the view. The view requests the new value stored in the model and the new value is applied to the view.

In some design patterns (like MVVM or MVP) the model and the view are not directly bound to each other. Instead, the view is bound to a third object, the view-model (or presenter). The view-model passes the change data to the model. In one implementation of this pattern, the view-model can act as a proxy between the view and the model.

One consequence of the view-model acting as a proxy is that events fired in the model do not reach the view. “Firing an event” means to call all event handlers which are registered to that event. Thus, when an event occurs in the model, the view-model has to fire an event of its own in order for the view to be updated with the event. One way to handle the need for the view-model to fire an event is for the view-model to catch the model's event and for the view-model to fire an appropriate event as well. The event fired by the view-model can be caught by the view, the view can request an update from the view-model and the view-model can send an update to the view. This solution requires a considerable amount of coding for each view-model element to model element connection. Coding can become complex, in particular when one element in the model affects more than one element in the view-model, tending to make this solution error prone.

The subject matter described herein provides an example of an observer (e.g., a view) that is registered to events in a subject (e.g., a model) indirectly using a proxy (e.g., a view-model). In accordance with aspects of the subject matter disclosed herein, a dependency informer can be created. The dependency informer can register to receive notifications of events in the first subject (e.g., the model). A table in the dependency informer can define the set of connections between pairs of elements. One of the elements can be in the first subject (e.g., the model) and its counterpart can be in the second subject (e.g., the view-model). The dependency informer can map between an element name or element identifier in the first subject and an element name or element identifier in the second subject. The dependency informer can map between an element name or element identifier in one subject and another element name or element identifier in the same subject. The dependency information can map between an element name in the first subject and a delegate. The delegate can be a pointer to a method to be invoked. The set of definition mappings can be used by the dependency informer to select the correct action to take when receiving an event from the first subject.

In response to detecting an event fired by the first subject, the dependency informer by default can fire a corresponding event in the second subject to notify the second observer (e.g., the view) about the event. In response to detecting an event fired by the first subject, the event including one or more parameters, the dependency informer can execute customized code based on the value of the parameter. For example, a property change event with a parameter of “Property1” can mean that the “Property1” property was changed while the same event with a parameter of “Property2” can indicate that the “Property2” property was changed, etc.). The customized code can execute one of a number of potential code paths in response to the content of the parameters associated with the event received from the first subject. The dependency informer object created can optionally prioritize the order in which the delegates are invoked. The dependency informer can be implemented as a class with a method that can be invoked upon detection of an event (e.g., an “OnEvent” action). For an event where the parameter of the event received from the first subject is some agreed-upon, specified or configured value (e.g., the value is empty or null), the agreed-upon value may signify that all the elements are affected, and that therefore all the delegates will be invoked. Similarly, an agreed-upon value may signify that the event refers to all possible parameter values.

### Dependency Informer

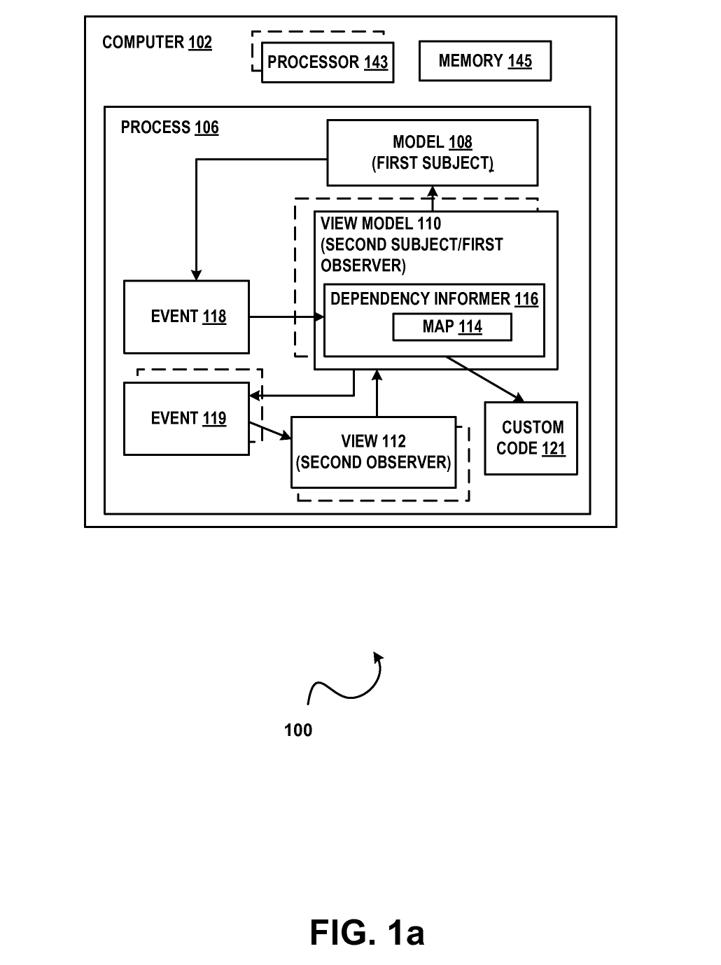

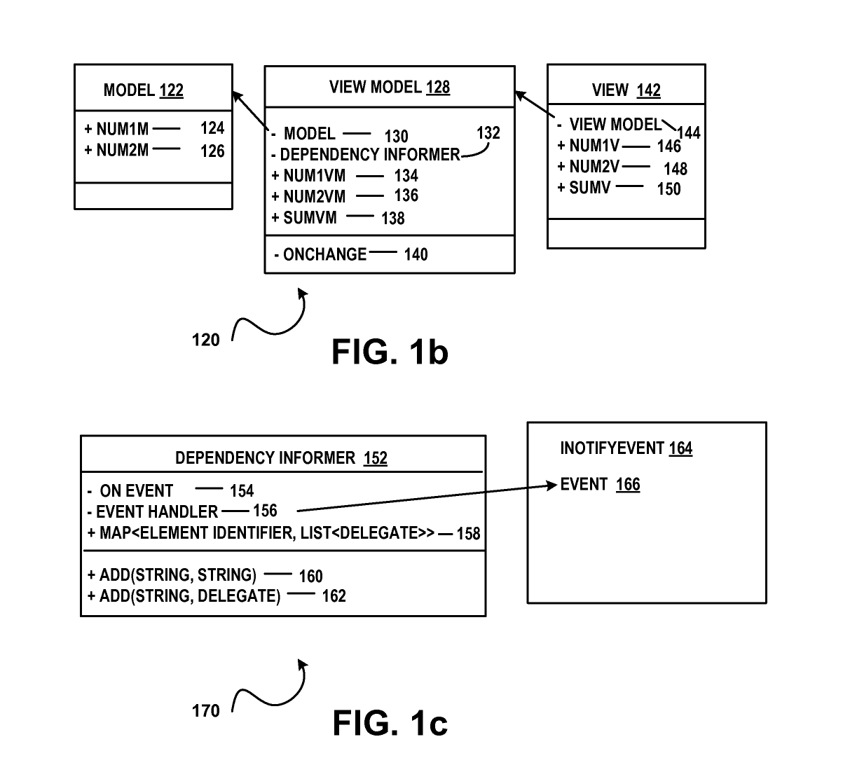

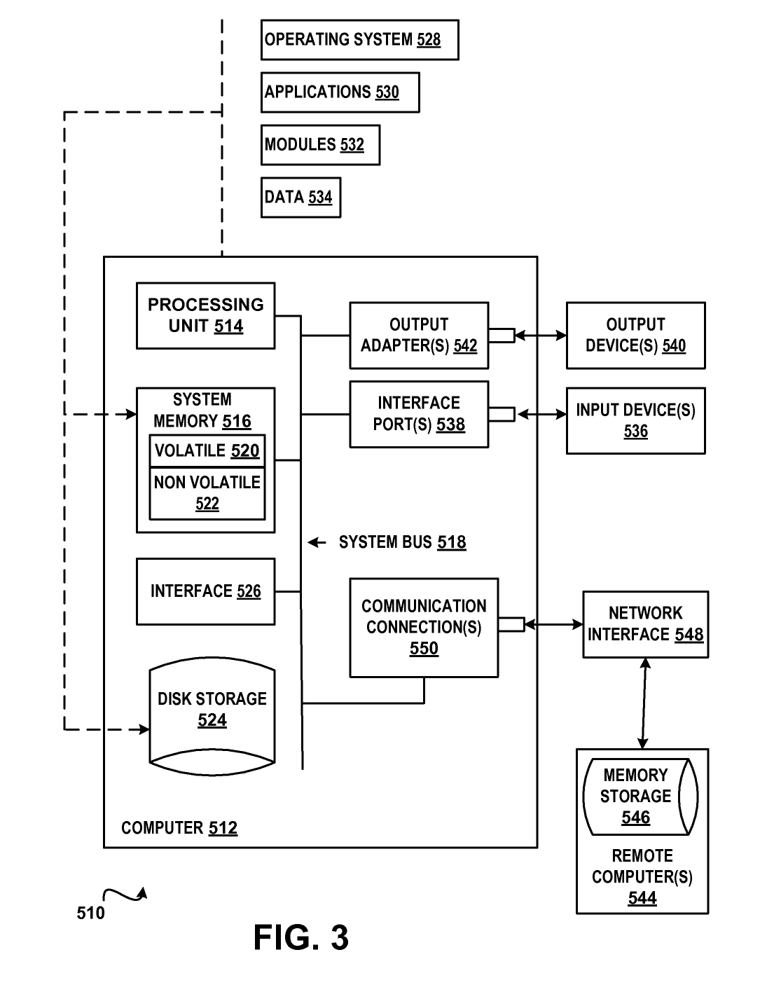

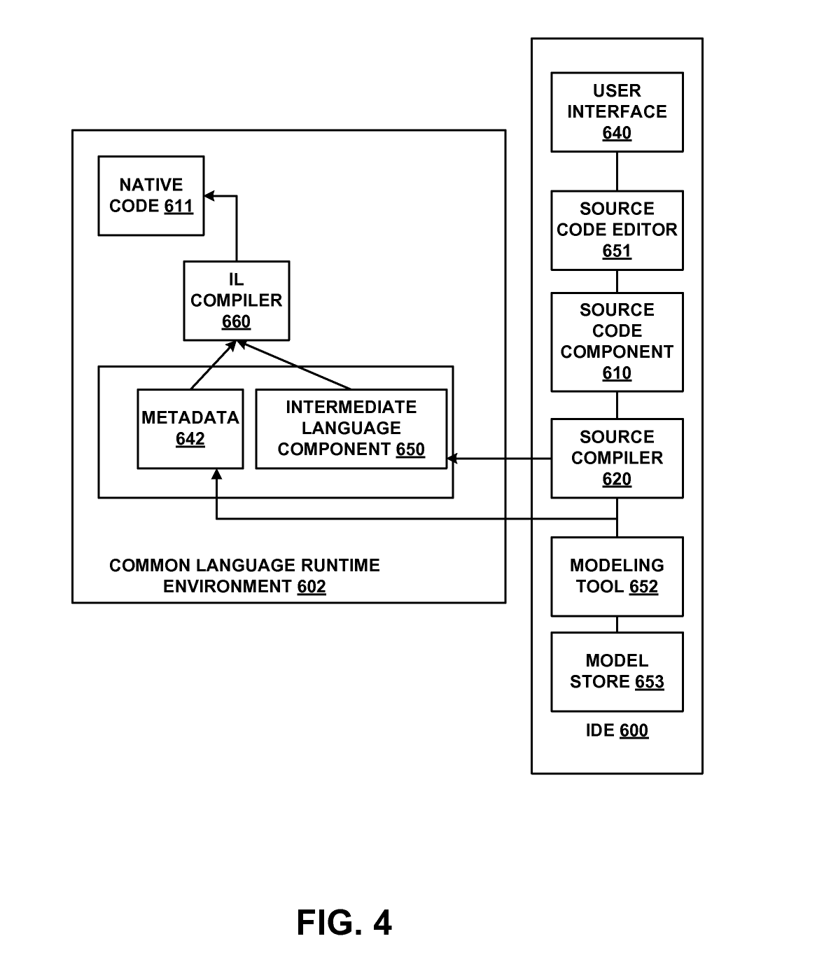

FIG. 1a illustrates an example of a system 100 that applies changes made to a model (e.g. first subject) to a view (e.g. second observer) using a dependency informer in accordance with aspects of the subject matter disclosed herein. All or portions of system 100 may reside on one or more computers such as the computers described below with respect to FIG. 3. System 100 may execute on a software development computer such as the software development computer described with respect to FIG. 4. System 100 or portions thereof may execute within an integrated development environment or IDE or may execute outside of an IDE. The IDE can be an IDE such as the one described with respect to FIG. 4 or can be any other IDE. All or portions of system 100 may be implemented as a plug-in or add-on.

System 100 may include one or more computers or computing, devices such as a computer 102 comprising: one or more processors such as processor 143, etc., a memory such as memory 145, and one or more program modules comprising a dependency informer such as dependency informer 116, which when loaded into the memory 145 cause the processor 143, etc. to execute the actions attributed to the dependency informer 116. A process such as process 106 may execute on computer 102. The process 106 may affect or may be affected by a model 108 that stores data on which the process 106 acts or on which the process 106 depends. System 100 may also include one or more view-models such as view-model 110, etc. and one or more views of the model such as view 112, etc. The model 108 can generate an event. The event (e.g., event 118) can be sent to the dependency informer 116. The event can identify an element in the model to which the event relates. The event can identify particular semantics of the event to which the sent event refers. One or more parameters can be used to identify the element in the model to which the event relates. One or more parameters can be used to identify the semantic to which the event refers.

An instance of the dependency informer 116 can be initialized in the view-model 110. The instance of the dependency informer 116 can be initialized with a delegate to a method in the view-model 110. The method in the view-model 110 can fire an event. Dependency informer 116 may use this method in order to fire events in view-model 110 which are associated with a reference to the events such as event 118 that occurred in the instance of the model 108. Connections between elements in the model 108 and elements in the view-model 110 can be defined. Alternatively, connections between elements in the model 108 and elements in the view-model 110 can be read from a configuration file by the dependency informer upon initialization or the connections between elements in the model 108 and elements in the view-model 110 can be read from a configuration file by an object that calls a series of add functions with the appropriate parameters.

Custom code behavior can also be configured. The custom code behavior can be invoked when one of the elements in the model 108 changes or when any event is fired by the model by creating a connection between an element in the model 108 and a delegate to a method which includes the custom code (e.g., custom code 121) or to an anonymous method which includes the custom code. An anonymous function is a function or subroutine that is defined or called without being bound to an identifier.

The dependency informer 116 can be initialized with an input parameter comprising a reference to an inspected (observed) object (i.e., the first subject). The inspected object can be any object that implements the interface with the referenced event. An input parameter can comprise a delegate to a method that fires an event in the containing object (i.e., the second subject including but not limited to a view-model such as view-model 110 that includes dependency informer 116). The dependency informer 116 can save the input parameters on initialization for later use. The dependency informer 116 can register to receive notifications whenever the event in the model 108 occurs.

The dependency informer 116 can maintain a mapping such as but not limited to map 114 between an element name and a list of delegates. Connections between the model (i.e., the first subject) elements and delegates can be added to the map. Connections can be forwarding connections. Connections can be splitting connections. When a forwarding connection is added, the dependency informer 116 can create a new delegate which, when called, can invoke the on event delegate method with the element identifier. This new delegate can be added to the map using the splitting method logic. When the model fires event such as change event 118, the dependency informer's event handler can be invoked. The dependency informer's event handler can check if the element identifier sent in the event exists in the map 114. If it does, the event handler can invoke one or more of the delegates in the list of delegates mapped to the element identifier to generate one or more events such as event 119, etc. If the event was fired with an agreed-upon, specified or configured value (e.g., an empty parameter), all the delegates in the map can be invoked.

FIG. 1b illustrates an example 120 of a use of a dependency informer in a system with a model 122 (i.e., first subject), a view-model 128 (i.e., first observer and second subject) and a view 142 (i.e., second observer). In accordance with aspects of the subject matter described herein, the view 142 can have a pointer 144 to the view-model 128. The view-model 128 can have a pointer 130 to the model 122. Suppose in the view there are text boxes or labels that display some or all of three numbers such as num2v 146, num2v 148 and sumv 150. Suppose sumv 150 is the sum of num1v 146 and num2v 148. Suppose the text boxes or labels display the data stored in corresponding elements of the model 122 for the numbers num1v 146 and num2v 148. Suppose the same elements exist in the view-model 128 as num1vm 134, num2vm 136 and sumvm 138. Suppose that in the model 122 only the corresponding element num1m 124 exists for num1vm 134, and model element num2m 126 corresponds to num2vm 136. Suppose the sum is not included in the model 122 because calculation of the sum is done in the UI logic.

In the example, num1v 146 can be bound to num1vm 134 and num2v 148 can be bound to num2vm 136. The value of num1m 124 can be returned to num1v 146 and the value of num2m 126 to num2v 148. Whenever num1m 124 changes, the change can be reflected in num1v 146. Whenever num2m 126 changes, the change can be reflected in num2v 148. Whenever either num1m 124 or num2m 126 changes, the change can be reflected in sumv 150. In accordance with aspects of the subject matter disclosed herein, changes in model elements can be reflected in values displayed in the view because the dependency informer 132 includes an change event handler that is invoked whenever the model 122 fires a change event. The change event handler can receive the element identifier of the model element that has changed allowing the dependency informer 132 to use the on change method 140 to fire a change event in the view model 128 with an appropriate element identifier.

To define the connections between the view-model 128 and the model 122, the dependency informer 132 can be informed of dependencies that exist between elements in the view-model 128 and the model 122. The dependency information comprises the mapping information. For example, dependency informer 132 can be told that num1vm 134 is dependent on num1m 124 and that num2vm136 is dependent on num2m 126. The dependency informer 132 can also be told that sumvm 138 is dependent on num1m 124 and num2m 126. Thus if num1m 124 changes, the model 122 can fire a change event identifying num1m 124 as the element that changed. The dependency informer 132 can catch that change event, and can access the map information. The map information will indicate that there are two elements that depend on num1m 124: num1vm 134 and sumvm 138. Dependency informer 132 can use the on change event 140 to which dependency informer 132 delegates, to inform the view-model 110 that the values for num1vm 134 and sumvm 138 have changed. The dependency informer 132 can call on change event 140 with num1vm 134 and sumvm 138A. change event can also be fired in the view-model 128 for num1vm 134 and sumvm 138. These change events can be caught by the view 142. The view 142 can see that num1m 134 and sumvm 138 have been updated. In response the view 142 can determine the updated values by asking the view-model 128 for num1vm 134 and the view-model 128 can return the value which it got from the model 122 for num1m 124. For sumv 150 the view-model 128 can be asked for sumvm 138. The view-model 128 can return the sum of num1m 124 and num2m 126. Alternatively, a second method (in addition to the on-change method 140) can be called to compute the sum of num1vm 134 and num2vm 136.

FIG. 1e illustrates an example 170 of a dependency informer 152 and an interface (e.g., INotifyEvent 164). A dependency informer 152 can include a delegate to an on event method 154, an event handler 156 and a map 158. The map 158 can include information including the element name and a list of delegates. The dependency informer 152 can also include one or more add methods (e.g., method 160 and method 162) having parameters comprising a string and a string or comprising a string and a delegate. The dependency informer 152 can have a pointer to the object that has the on event method in it. For example, in FIG. 1b, dependency informer 132 has the pointer to the on change method 140 inside view-model 128. The dependency informer 152 of FIG. 1c can also have an event handler such as event handler 156. The event handler 156 can register for the event 166 of the INotifyEvent interface 164. INotifyEvent interface 164 in this example is an interface that declares the event. To register to receive notifications when events occur, the object can implement this interface. In the example, the model implements the INotifyEvent interface 164 with the Event 166 event.

The dependency informer 152 is given the pointer to the model which implements INotifyEvent interface 164. Since model 122 implements interface 164, the dependency informer 152 can register event handler 156 to the model's event by using Event 166 defined in the INotifyEvent interface 164. The dependency informer 152 can then register for the events fired by the model. By registering, the dependency informer 152 will be told to call the event handler 156 whenever the event fires. The dependency informer 152 also includes the map 158 which has the element identifier and a list of delegates. The map holds the definitions of dependencies described above between the objects. In FIG. 1b, the dependencies defined included: num1vm 134 is dependent on num1m 124, and sumvm 138 is dependent on num1m 124. The second parameter is a list of delegates. Because num1vm 134 (b) depends on num1m 124 (a), a delegate which calls the on change event 140 for num1vm 134 can be added into the list for the key num1m 124. Whenever num1m 124 fires a change event, a change event in view model 128 can be fired with num1vm 134 as the parameter. Similarly, when the connection between num1m 128 and sumvm 138 is defined, the dependency informer 132 can check the map for a key of num1m 124. If a key of num1m 124 is found, the list of delegates can be retrieved and the delegate related to sumvm 138 can be added to the list of delegates. If the key of num1m is not found, a new list of delegates can be created and the delegate related to sumvm 138 can be added to the new list of delegates.

Dependency informer 152 may include two add methods, one which gets two strings, add method 160 and one which gets a string and a delegate, add method 162. Add method 162 gets a string and a delegate. The string reflects the identifier of an event parameter in the first subject (e.g. element in the model) and the delegate reflects an action or actions to be taken. For example, suppose num1m 124 changes, and the action to be taken is to change the background color by calling a method called changebackgroundcolor. Add method 162 can be called with num1m 124 as the first parameter and a pointer to the changebackgroundcolor method as the second parameter. The dependency informer can go to the map, and search for a key of num1m 124 in the map. If the key of num1m 124 is found in the map, the list of delegates can be retrieved and the delegate (the pointer to the changebackgroundcolor method) can be added to the list of delegates.

In the second add method, method 160, the same logic can execute except that instead of having a delegate, the add method would have an event parameter in the second object (e.g. view-model's element identifier) as the second parameter. A new delegate can be created. The action of the new delegate can be to call on event (e.g., OnEvent 154) created in the first field with the second string as the parameter. Change event handler can handle the firing of the change event. The change event can be formed with the element name as a parameter. The change event handler can receive the element name and search the map for a key with this element name. If there is no key with the element name, nothing else has to be done. If the key with the element name is found, each delegate in the list of delegates can be called, invoking whatever method the delegate in the list calls.

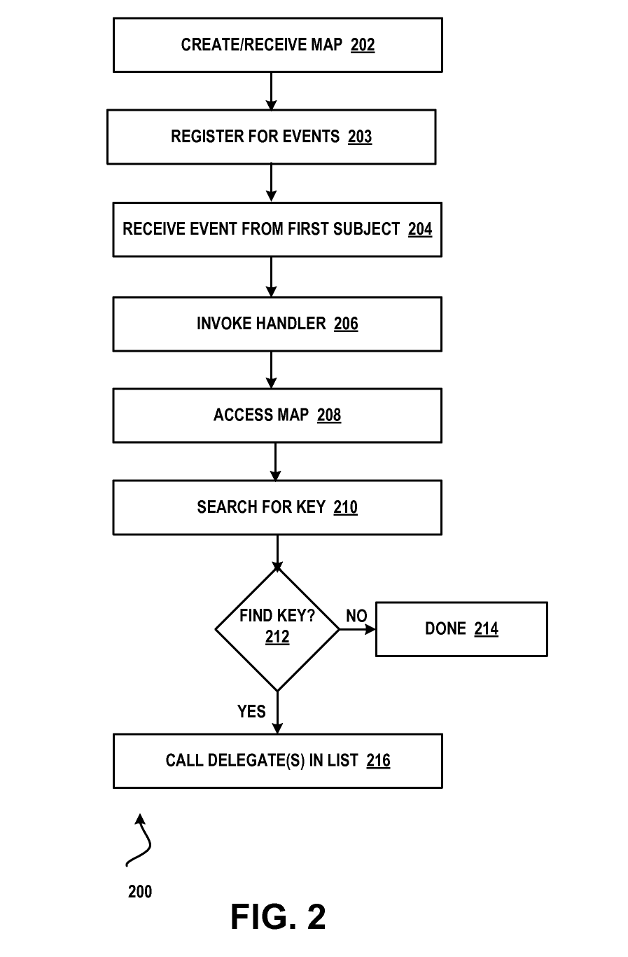

FIG. 2 illustrates a method 200 that can use a dependency informer to apply changes made to a model to a view in accordance with aspects of the subject matter disclosed herein. The method described in FIG. 2 can be practiced by a system such as but not limited to the one described with respect to FIG. 1a and for which examples were provided in FIGS. 1b and 1c. While method 200 describes a series of acts that are performed in a sequence, it is to be understood that method 200 is not limited by the order of the sequence. For instance, some acts may occur in a different order than that described. In addition, an act may occur concurrently with another act. In some instances, not all acts may be performed.

At 202 a map, as described more fully above, can be received. The dependency informer can register for the event in the first subject (e.g. model) at 203. At 204 an event fired by a first subject can be received by the dependency informer. The event can identify different semantics of the event by using a parameter. At 206 the dependency informer's event handler can be invoked. At 208 the dependency informer can access its map to determine what delegates need to be invoked. At 210 the dependency map can be searched for a key matching the parameter sent by the event. At 212 if the key is found, each delegate in the list can be invoked at 216. At 214 if the key is not found in the map the process can end.

### Example of a Suitable Computing Environment

In order to provide context for various aspects of the subject matter disclosed herein, FIG. 3 and the following discussion are intended to provide a brief general description of a suitable computing environment 510 in which various embodiments of the subject matter disclosed herein may be implemented. While the subject matter disclosed herein is described in the general context of computer-executable instructions, such as program modules, executed by one or more computers or other computing devices, those skilled in the art will recognize that portions of the subject matter disclosed herein can also be implemented in combination with other program modules and/or a combination of hardware and software. Generally, program modules include routines, programs, objects, physical artifacts, data structures, etc. that perform particular tasks or implement particular data types. Typically, the functionality of the program modules may be combined or distributed as desired in various embodiments. The computing environment 510 is only one example of a suitable operating environment and is not intended to limit the scope of use or functionality of the subject matter disclosed herein.

With reference to FIG. 3, a computing device in the form of a computer 512 is described. Computer 512 may include at least one processing unit 514, a system memory 516, and a system bus 518. The at least one processing unit 514 can execute instructions that are stored in a memory such as but not limited to system memory 516. The processing unit 514 can be any of various available processors. For example, the processing unit 514 can be a GPU. The instructions can be instructions for implementing functionality carried out by one or more components or modules discussed above or instructions for implementing one or more of the methods described above. Dual microprocessors and other multiprocessor architectures also can be employed as the processing unit 514. The computer 512 may be used in a system that supports rendering graphics on a display screen. In another example, at least a portion of the computing device can be used in a system that comprises a graphical processing unit. The system memory 516 may include volatile memory 520 and nonvolatile memory 522. Nonvolatile memory 522 can include read only memory (ROM), programmable ROM (PROM), electrically programmable ROM (EPROM) or flash memory. Volatile memory 520 may include random access memory (RAM) which may act as external cache memory. The system bus 518 couples system physical artifacts including the system memory 516 to the processing unit 514. The system bus 518 can be any of several types including a memory bus, memory controller, peripheral bus, external bus, or local bus and may use any variety of available bus architectures. Computer 512 may include a data store accessible by the processing unit 514 by way of the system bus 518. The data store may include executable instructions, 3D models, materials, textures and so on for graphics rendering.

Computer 512 typically includes a variety of computer readable media such as volatile and nonvolatile media, removable and non-removable media. Computer storage media may be implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other transitory or non-transitory medium which can be used to store the desired information and which can be accessed by computer 512.

It will be appreciated that FIG. 3 describes software that can act as an intermediary between users and computer resources. This software may include an operating system 528 which can be stored on disk storage 524, and which can allocate resources of the computer 512. Disk storage 524 may be a hard disk drive connected to the system bus 518 through a non-removable memory interface such as interface 526. System applications 530 take advantage of the management of resources by operating system 528 through program modules 532 and program data 534 stored either in system memory 516 or on disk storage 524. It will be appreciated that computers can be implemented with various operating systems or combinations of operating systems.

A user can enter commands or information into the computer 512 through an input device(s) 536. Input devices 536 include but are not limited to a pointing device such as a mouse, trackball, stylus, touch pad, keyboard, microphone, and the like. These and other input devices connect to the processing unit 514 through the system bus 518 via interface port(s) 538. An interface port(s) 538 may represent a serial port, parallel port, universal serial bus (USB) and the like. Output devices(s) 540 may use the same type of ports as do the input devices. Output adapter 542 is provided to illustrate that there are some output devices 540 like monitors, speakers and printers that require particular adapters. Output adapters 542 include but are not limited to video and sound cards that provide a connection between the output device 540 and the system bus 518. Other devices and/or systems or devices such as remote computer(s) 544 may provide both input and output capabilities.

Computer 512 can operate in a networked environment using logical connections to one or more remote computers, such as a remote computer(s) 544. The remote computer 544 can be a personal computer, a server, a router, a network PC, a peer device or other common network node, and typically includes many or all of the elements described above relative to the computer 512, although only a memory storage device 546 has been illustrated in FIG. 3. Remote computer(s) 544 can be logically connected via communication connection(s) 550. Network interface 548 encompasses communication networks such as local area networks (LANs) and wide area networks (WANs) but may also include other networks. Communication connection(s) 550 refers to the hardware/software employed to connect the network interface 548 to the bus 518. Communication connection(s) 550 may be internal to or external to computer 512 and include internal and external technologies such as modems (telephone, cable, DSL and wireless and ISDN adapters, Ethernet cards and so on.

It will be appreciated that the network connections shown are examples only and other means of establishing a communications link between the computers may be used. One of ordinary skill in the art can appreciate that a computer 512 or other client device can be deployed as part of a computer network. In this regard, the subject matter disclosed herein may pertain to any computer system having any number of memory or storage units, and any number of applications and processes occurring across any number of storage units or volumes. Aspects of the subject matter disclosed herein may apply to an environment with server computers and client computers deployed in a network environment, having remote or local storage. Aspects of the subject matter disclosed herein may also apply to a standalone computing device, having programming language functionality, interpretation and execution capabilities.

FIG. 4 illustrates an integrated development environment (IDE) 600 and Common Language Runtime Environment 602. An IDE 600 may allow a user (e.g., developer, programmer, designer, coder, etc) to design, code, compile, test, run, edit, debug or build a program, set of programs, web sites, web applications, and web services in a computer system. Software programs can include source code (component 610), created in one or more source code languages (e.g., Visual Basic, Visual J#, C++, C#, J#, Java Script, APL, COBOL, Pascal, Eiffel, Haskell, ML, Oberon, Perl, Python, Scheme, Smalltalk and the like), The IDE 600 may provide a native code development environment or may provide a managed code development that runs on a virtual machine or may provide a combination thereof. The IDE 600 may provide a managed code development environment using the .NET framework. An intermediate language component 650 may be created from the source code component 610 and the native code component 611 using a language specific source compiler 620 using a modeling tool 652 and model store 653 and the native code component 611 (e.g., machine executable instructions) is created from the intermediate language component 650 using the intermediate language compiler 660 (e.g. just-in-time (HT) compiler), when the application is executed. That is, when an IL application is executed, it is compiled while being executed into the appropriate machine language for the platform it is being executed on, thereby making code portable across several platforms. Alternatively, in other embodiments, programs may be compiled to native code machine language (not shown) appropriate for its intended platform.

A user can create and/or edit the source code component according to known software programming techniques and the specific logical and syntactical rules associated with a particular source language via a user interface 640 and a source code editor 651 in the IDE 600. Thereafter, the source code component 610 can be compiled via a source compiler 620, whereby an intermediate language representation of the program may be created, such as assembly 630. The assembly 630 may comprise the intermediate language component 650 and metadata 642. Application designs may be able to be validated before deployment.

The various techniques described herein may be implemented in connection with hardware or software or, where appropriate, with a combination of both. Thus, the methods and apparatus described herein, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing aspects of the subject matter disclosed herein. As used herein, the term “machine-readable medium” shall be taken to exclude any mechanism that provides (i.e., stores and/or transmits) any form of propagated signals. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects, e.g., through the use of a data processing API or the like, may be implemented in a high level procedural or object oriented programming language to communicate with a computer system. However, the program(s) can be implemented in assembly or machine language, if desired. In any case, the language may be a compiled or interpreted language, and combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A system comprising:
at least one processor of a computing device;
a memory of the computing device; and
a dependency informer comprising at least one module loaded into the memory causing the at least one processor to:
receive a set of dependencies between at least one pair of elements, a first element of the at least one pair of elements identifying an event semantic in a first subject, and a second element of the at least one pair of elements comprising a corresponding element in a second subject;
generate from the received set of dependencies, a map comprising a key and at least one delegate associated with the key;
receive an event at the dependency informer, the event fired by the first subject identifying the semantic to which the event refers;
in response to a finding a key in the map, the key corresponding to the identified semantic, executing program code associated with the at least one delegate.

2. The system of claim 1, wherein the second subject comprises the first subject.

3. The system of claim 1, further comprising:
at least one module loaded into the memory causing the at least one processor to:
use the received set of dependencies to select program code to invoke in response to receiving the event fired by the first subject.

4. The system of claim 1, further comprising:
at least one module loaded into the memory causing the at least one processor to:
receive at the dependency informer the event fired by the first subject, the event comprising at least one parameter distinguishing between different semantics of the event.

5. The system of claim 1, further comprising:
at least one module loaded into the memory causing the at least one processor to:
maintain a map comprising an element identifier and a list of delegates; and
in response to receiving a parameter comprising an agreed-upon value, invoking all the delegates in the list of delegates.

6. The system of claim 1, further comprising:
at least one module loaded into the memory causing the at least one processor to:
maintain a map comprising an element identifier and a list of delegates associated with the element identifier, wherein in response to receiving a parameter comprising the element identifier, delegates in the list of delegates are invoked.

7. The system of claim 1, the first subject comprising a model and the second subject comprising a view-model.

8. The system of claim 1, further comprising:
at least one module loaded into the memory causing the at least one processor to:
call a method having a first parameter comprising a first element identifier and a second parameter comprising a second element identifier; and
create a new delegate, the new delegate calling a method with the second identifier as a parameter and adding the new delegate to the map with the first parameter as a key for the second identifier.

9. A method comprising:
receiving by a processor of a computer, a map comprising a set of dependency connections between at least one pair of elements, one element of the pair of elements comprising an element in the model and one element of the pair of elements comprising a corresponding element in the view-model;
receiving an event fired by the model, the event identifying an element in the model to which the event applies;
invoking an event handler at a dependency informer module of the view-model;
searching for a key comprising the element identifier in the map to determine at least one delegate to invoke; and
in response to finding the key, invoking each delegate in a list of delegates associated with the key.

10. The method of claim 9, further comprising:
calling a method having a first parameter comprising a first element identifier and a second parameter comprising a second element identifier;
creating a new delegate, the new delegate calling a method with the second element identifier as a parameter and adding the new delegate to the map.

11. The method of claim 9, further comprising:
prioritizing an order in which the delegates in the list of delegates are invoked.

12. The method of claim 9, further comprising:
receiving the event fired at the view-model, the at least one parameter distinguishing between different semantics of the event.

13. The method of claim 9, further comprising:
generating an event fired by the view-model, the event corresponding to the event received at the view-model.

14. The method of claim 9, further comprising:
using the received set of dependencies to select an event to fire in response to receiving at the view-model the event fired by the model.

15. A computer-readable storage medium comprising computer-executable instructions which when executed cause at least one processor of a computing device to:
receive a mapping comprising a set of dependencies between at least one pair of elements, a first element of the pair of elements comprising an element in a first subject, and a second element of the pair of elements comprising a corresponding element in a second subject;
generate from the received set of dependencies, a map comprising a key and at least one delegate associated with the key, the at least one delegate associated with custom code;
receive an event at a dependency informer module of the second subject, the event fired by the first subject identifying the element to which the event refers by including an element identifier for the element;
use the received set of dependencies to select custom program code to invoke in response to receiving the event fired by the first subject;
search for a key comprising the element identifier in the map to determine at least one action to take; and
invoke at least one delegate in a list of delegates associated with the key.

16. The computer-readable storage medium of claim 15, comprising further computer-executable instructions, which when executed cause at least one processor to:
call a method having a first parameter comprising a first element identifier and a second parameter comprising a second element identifier; and
create a new delegate, the new delegate calling a method with the second element identifier as a parameter and adding the new delegate to the map.

17. The computer-readable storage medium of claim 15, comprising further computer-executable instructions, which when executed cause at least one processor to:
generate an event fired by the second subject, the event corresponding to the event fired by the first subject.

18. The computer-readable storage medium of claim 15, comprising further computer-executable instructions, which when executed cause at least one processor to:
receive at the dependency informer the event fired by the first subject, at least one parameter of the event distinguishing between different semantics of the event.

19. The computer-readable storage medium of claim 15, comprising further computer-executable instructions, which when executed cause at least one processor to:
use the received set of dependencies to select an action to take in response to receiving at the dependency informer the event fired by the first subject.

20. The computer-readable storage medium of claim 15, comprising further computer-executable instructions, which when executed cause at least one processor to:
maintain a map comprising an element identifier and a list of delegates, wherein in response to receiving a specified parameter all the delegates in the list of delegates are invoked.
